(19) United States
(12) Patent Application Publication
(10) Pub. No.: US 2016/0148333 A1
(43) Pub. Date: May 26, 2016

(54) Business Advertising Method

(71) Applicant: Bijan Dokhanian, Beverly Hills, CA (US)

(72) Inventors: Bijan Dokhanian, Beverly Hills, CA (US); Zoltan Kemeny, Chandler, AZ (US)

(21) Appl. No.: 14/757,190

(22) Filed: Dec. 2, 2015

(51) Int. Cl. G06Q 90/00

(52) U.S. Cl. CPC G06Q 90/00

(57) ABSTRACT

Disclosed is a method, which consists of advertising on consumer goods packaging, whereas said advertisement is unrelated to the content of said packaging, and whereas the advertiser pays for the advertisement placement on said packaging, at the extent which, as a minimum, covers the cost of said packaging. Packaged merchandise carried by shippers or customers are seen by many in public for sufficient time and extent to validate renting visible surfaces of packages, advertising one thing and containing another, without confusing anyone. To a store keeper, at least the packaging can be free this way.

### FIELD OF THE INVENTION

This invention relates to advertising products on packaging of other products.

### BACKGROUND OF THE INVENTION

The invention fulfills the need for reducing or eliminating at least the packaging material cost of products by advertising on the packaging other products, unrelated to the product the package contains. Once other companies' advertisement pays for the cost of bags, boxes, wrappings and such packaging goods, the packaging can be free to the company, who packages its merchandize in such packages. That company may even make money by renting to others, like advertising agencies, advertising space on packages containing the company's product. Advertisement on the package shall not be in conflict with what is packaged inside.

Some inventor proposed advertising on buildings, walls, windows, billboards and many stationary structures, which are seen by many potential buyers of products advertised. Others proposed advertising on moving surfaces, such as cars, trucks, busses, trains, and airplanes and such. In any case either the advertisement moves, so many can see it, or it stays, but the people move, so many can see it that way. Bags, wrappings, boxes and other packages or packaging materials, move, carried by shippers or customers and seen by others for a while, while in transit or on display or being discarded, yet, still seen by some.

It is customary to advertise one's own brand or product. For instance, when you buy grocery in Whole Foods, they pack it for you in bags with full of advertisement, advertising Whole Foods, by its logo and products. It is novel to advertise Chase Bank, Food Club, Farmers Market, Green Choices Recycling or the next coming Annual Meeting of the National Grocers Association on that bag.

It is therefore the object of this invention to disclose a new business method, which specifies such “other people's product” or “third party interest” advertising on the outer surfaces of packages of merchandize not directly related to that merchandize.

### SUMMARY OF THE INVENTION

The above problems and others are at least partially solved and the above objects and others realized in a process, which according to the teachings of this invention, uses third party printed advertisements on packages of consumer goods, whereas said packages includes, bags, wrappings, boxes and such, and whereas said goods includes consumer products, appliances, food, grocery and such, and whereas said package is expected to be seen by several others than the purchaser of said goods and expected to be carried in public places by the shopper or a carrier as shipper.

The store pays for the packaging material and gets paid for allowing others to advertise on the outer surfaces of said packaging. Revenues from that advertising right licensing is expected to offset the cost of said packaging. Also, to exceed it, so the store can make money on its packaging.

Through agreement or contract, the store controls whose advertisement is allowed on its packaging. The store may contract advertising agencies to supply said packaging materials on a continuous base, whereas the actual prints of particular advertisements would vary time to time, as the agency decides about that. The store may restrict certain kind of advertisements on its packages, for instant the ones, which may be incompatible with the products expected to be packaged by the store.

### BRIEF DESCRIPTION OF THE DRAWINGS

Referring to the drawings:

FIG. 1 is an isometric view of a packaging box as an exemplary embodiment of the invention.

FIG. 2 is a photographic view of a handbag as another exemplary embodiment of the invention.

FIG. 3 is a photographic view of a paper bag as yet another exemplary embodiment of the invention.

FIG. 4 is a photographic view of a tote bag as yet another exemplary embodiment of the invention.

FIG. 5 is a photographic view of a paper canister as yet another exemplary embodiment of the invention.

FIG. 6 is a photographic view of a carton box as a final exemplary embodiment of the invention.

### DETAILED DESCRIPTION OF A PREFERRED EMBODIMENT

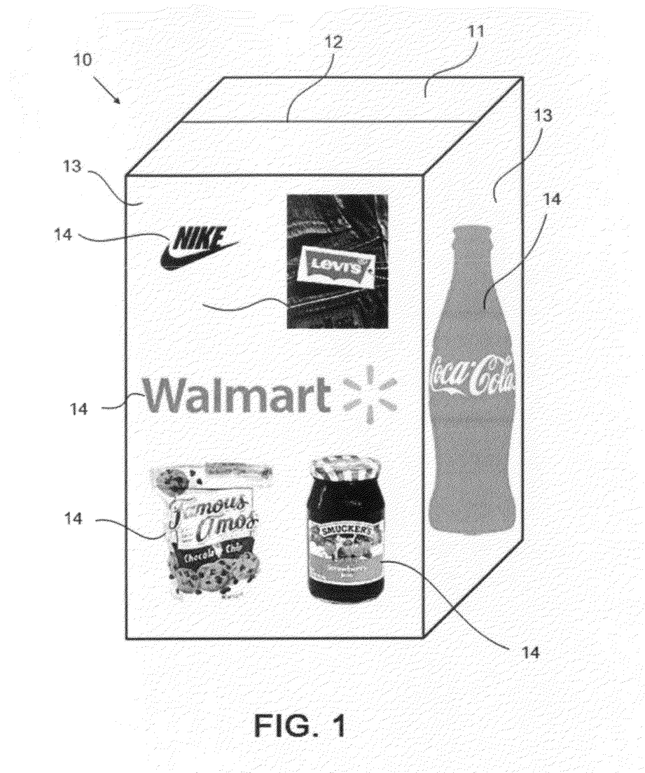

Attention is now turned to FIG. 1, which illustrates an exemplary embodiment of the invention, Box 10, labelled with advertisement as per the teachings of the invention.

Box 10, is a large carton box, which may wrap a refrigerator or a similarly large size merchandize. Its top 11 fold at line 12, where the box is sealed, typically by tape. Its four sides 13 are suitable to carry advertisements unrelated to the packed refrigerator. Six exemplary advertisements, prints 14, are shown for illustration. Sides 13 ant top 11 may also carry prints, some of which may have reference to the merchandise packed inside.

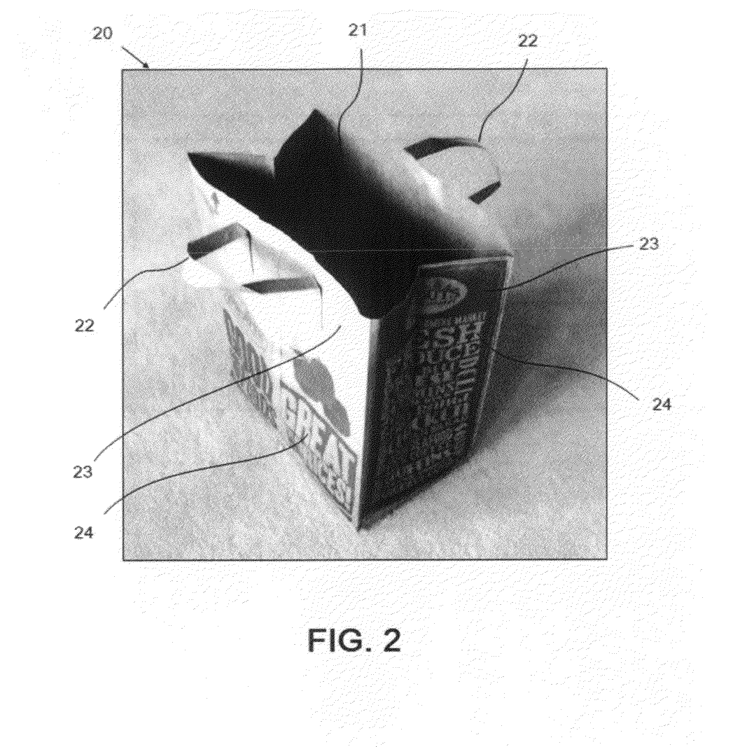

Attention is now turned to FIG. 2, which illustrates another exemplary embodiment of the invention, Handbag 20, labelled with advertisement as per the teachings of the invention.

Handbag 20 opens at top 21, has two handles 22, four sides 23 with printed advertisements 23. In one side, Bag 20 may advertise the store, where merchandise is packed in it, and on other sides may advertise other store's or manufacturer's products or services. Bag 20 can be made of paper, plastic, fabric or other suitable material.

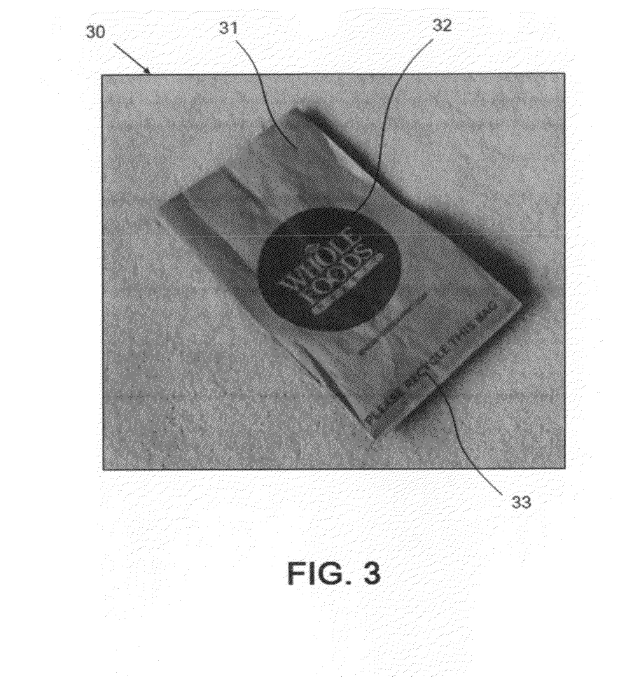

Attention is now turned to FIG. 3, which illustrates another exemplary embodiment of the invention, paper Bag 30, labelled with advertisement as per the teachings of the invention.

Bag 30 is a small paper bag, opening at one end. Its two surface carries printed ads 32 and warning label or public announcement or actionable slogan 33. It advertises anything but what it holds inside.

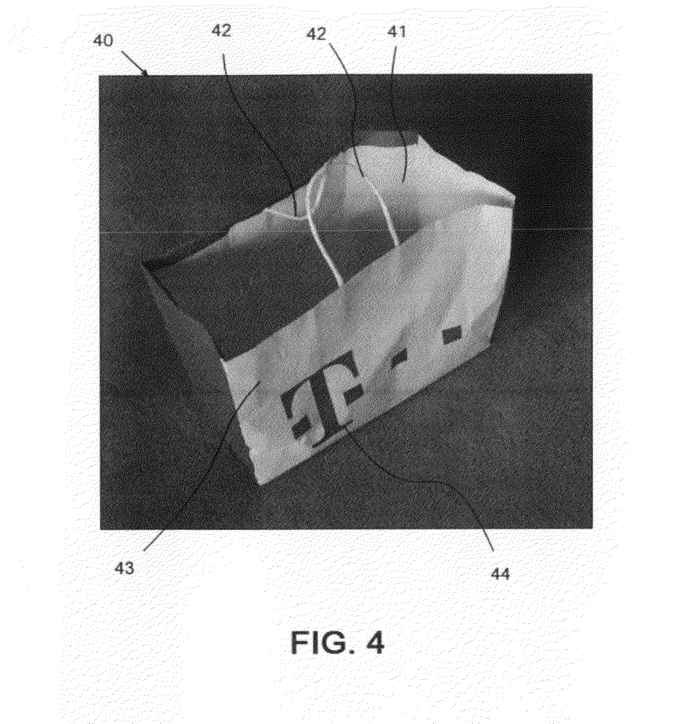

Attention is now turned to FIG. 4, which illustrates another exemplary embodiment of the invention, tote Bag 40, labelled with advertisement as per the teachings of the invention.

Bag 40 is of paper or plastic or fabric or such, opens at top 41, have two handles 42,sides for ads 43 ad printed ads 44, to advertise other people's products or services, preferably unrelated to the merchandise it normally carries.

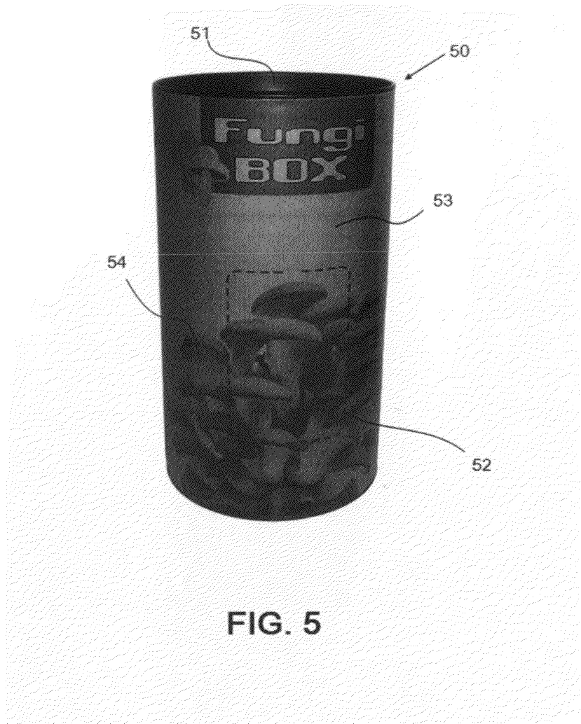

Attention is now turned to FIG. 5, which illustrates another exemplary embodiment of the invention, paper Canister 50, labelled with advertisement as per the teachings of the invention.

Canister 50 has removable lid 51, brake through opening line 52, circular surface 53, and printed advertisement 54. If it contains fungi, for example, on the front, it may say so, but must advertise something else on the opposite side.

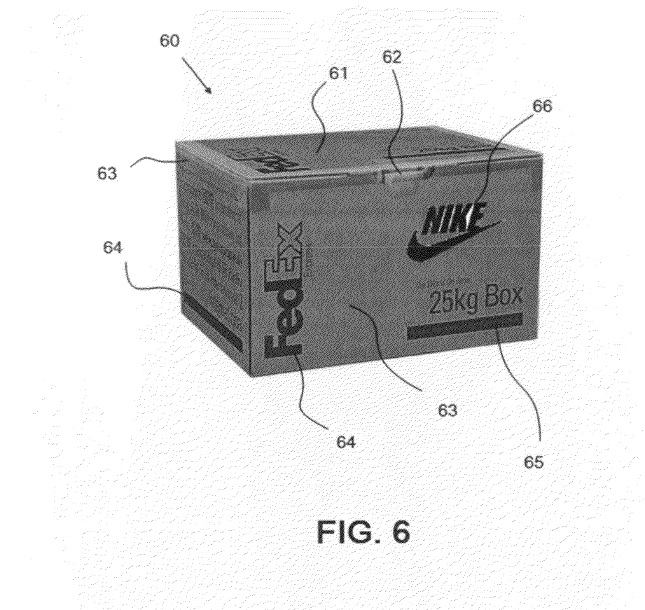

Attention is finally turned to FIG. 6, which illustrates another exemplary embodiment of the invention, carton Box 50, labelled with advertisement as per the teachings of the invention.

Box 60 has top lid 61, sealed by seal 62, four sides 63 for ads, printed company logo 64, and labels 65, which relates to the shipping company's regulations regarding the content and other businesses' advertisement 66.

The present invention is described above with reference to a preferred embodiment. However, those skilled in the art will recognize that changes and modifications may be made in the described embodiment without departing from the nature and scope of the present invention. For instance, advertising other people's name, product, services, events and slogans on metal boxes, containers and other objects, which can, but not necessarily intended to package products is considered intuitive, and thus to be within the scope of the invention.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Method comprising advertising on consumer goods packaging, whereas said advertisement is unrelated to the content of said packaging, and whereas the advertiser pays for the advertisement placement on said packaging, at the extent which, as a minimum, covers the cost of said packaging.

2. Method as per claim 1, whereas a multiplicity of said advertisements are placed on said packaging.

4. Method as per claim 1, whereas, over time, a variety of said advertisements are placed on said packaging.

5. Method as per claim 1, whereas said payment exceeds said packaging cost.
